(19) United States
(12) Patent Application Publication
(10) Pub. No.: US 2014/0173677 A1
(43) Pub. Date: Jun. 19, 2014

(54) MEDIA STREAM HANDLING

(71) Applicants: Thorsten Lohmar, Aachen (DE); Kun Chen, Shanghai (CN); Jian Li, Adelaide (AU)

(72) Inventors: Thorsten Lohmar, Aachen (DE); Kun Chen, Shanghai (CN); Jian Li, Adelaide (AU)

(73) Assignee: TELEFONAKTIEBOLAGET L M ERICSSON (PUBL), Stockholm (SE)

(21) Appl. No.: 14/238,018

(22) PCT Filed: Aug. 10, 2012
(86) PCT No.: PCT/EP2012/003422

§ 371 Date: Feb. 10, 2014

(30) Foreign Application Priority Data
Aug. 10, 2011 (CN) PCT/CN2011/001321

(51) Int. Cl. H04N 21/44; H04N 21/845

(52) U.S. Cl. CPC H04N 21/44016; H04N 21/8456
USPC 725/116

(57) ABSTRACT

The invention refers to providing a sequence of media segments (21, 22, 23) to a media player (111) to be fetched one after another, wherein the media segments are generated from data packets received at a media receiver (112), the media receiver detecting that a certain media segment (22) cannot be recovered from the received data packets, and generating a replacement media segment (22′) to be fetched by the media player instead of the certain media segment. The information further refers to a corresponding media receiver (112) and a corresponding computer program.

### TECHNICAL FIELD

The present invention generally relates to broadcast or multicast media streaming, and especially related to handling transmission insufficiencies.

### BACKGROUND

Adaptive streaming is becoming an important content streaming technique. A number of different HTTP streaming techniques exist such as HTTP Live Streaming (HLS) proposed by Apple Inc., Microsoft Smooth streaming (ISM) and MPEG DASH being specified by 3GPP (wherein the abbreviation DASH stands for Dynamic Adaptive Streaming over HTTP).

Adaptive HTTP streaming technique have common principles in that a client receives a content stream as a sequence of files (or as a sequence of byte-range requests), which is to be decoded and finally played as a continuous media stream. The link information (URLs) of the file sequence are described in a so-called manifest file, e.g. in a so-called m3u or m3u8 file format for storing multimedia playlists in case of HLS, an ismc file format in case of Microsoft ISM and an MPD file format in case of DASH.

In case of sending DASH content (mostly Media Segments) over a Multimedia Broadcast Multicast Service (MBMS), the client receives a continuous file stream of media segments, each media segment comprising a unique address (URI).

The client fetches one media segment (file) after each other as described in the manifest file. During file download, the client might estimate the available link bitrate (download speed). Depending on the difference between the available link bitrate and the encoded bitrate of the media, the client might select an appropriate quality representation (e.g. slightly lower than the measured link bitrate).

To prepare a continuous stream of content for adaptive HTTP streaming, the stream is segmented into a plurality of media segments (files) on the server side. These media segments are fetched by the client (one after the other) as independent files. The client takes care to play to provide a continuous stream playout.

One problem relates to a handling of data segment that cannot be decoded at the client side; e.g. due to transmission problems between the server and the client. If e.g. a receiver according to the IETF document RFC 3926, titled “FLUTE—File Delivery over Unidirectional Transport”, specifying a protocol for a massively scalable reliable delivery of objects (files, directories, clips, ESG, etc.) over unidirectional transport, such receiver in the following also being referred to as FLUTE or as ALC/FLUTE receiver, is not able to recover a media segment (e.g. if redundancy data is not sufficient to perform a forward error correction in the receiver), the receiver might discard the entire media segment. In multicast or unicast transmission, it is however not possible for the client to request for a second transmission of the lost media segment file. The client's media player (e.g. a DASH or HLS compliant media player) might just stall the media playing until an expected media segment received.

### SUMMARY

It is an object of the present invention to improve a media display (or play-out) at a media player in cases of transmission disruptions or insufficiencies.

According to an embodiment, a client arrangement comprises a media receiver and a media player. The media receiver receives a sequence of data packets (e.g. UDP packets) from a media server and generates a plurality of consecutive media segments from the data of the received data packets to be fetched by the media player one after the other. In a case that a media segment cannot be recovered (e.g. due to transmission problems) the media receiver provides a replacement segment, also being referred to a dummy media segment, to be provided to the media player instead of the non-recovered (expected) media segment.

The client arrangement can be single physical device or can alternatively comprise several communicatively coupled physical devices. Specifically, the client arrangement might comprise a media player device coupled with a media receiver device.

An advantage of the above-described embodiment is that the media player can be kept playing without further waiting for the expected but lost data.

In a further embodiment, the media receiver generates a replacement segment such that the media player can use this segment without any further information, e.g. without out-of-band transmission. Thereto the media receiver might determine necessary control and decoding- & play-time related information to be inserted into the replacement segment (additionally to content replacement data, e.g. pre-defined default data (null data or “dummy content”)), e.g. time stamp information, counter and/or sequence number(s). This information might be derived from data associated to one or a plurality of previous media segments and internal calculation.

The internal calculation may comprise determining a time increment and adding this increment to a time stamp of a last valid media segment and/or by determining (incrementing) appropriate counters and/or sequence numbers).

In a further embodiment, the receiver inserts a certain amount of replacement data into the replacement media segment such that the duration of the replacement media segment corresponds to a calculated and/or expected duration of the non-recovered media segment. Thereto, the media player might insert a certain number of frames with replacement data (e.g. null frames or “black” frames) into the replacement media segment, wherein the number of frames corresponds to the duration of the non-recovered media segment.

In an embodiment thereto, if the receiver has already received and recovered a next media segment (after a non-recovered media segment), the receiver determines the media segment duration from timing information of both the media segment before the non-recovered media segment (e.g. the last valid media segment) and the recovered next media segment (e.g. calculating a time difference between a time value of the tfdt box of the next media segment minus a time value of tfdt box from the last valid media segment).

In case multiple media segments are missing, the receiver might create media segments with a default media segment duration. If a first media segment is correctly received after a plurality of non-recovered media segments, the receiver modifies the last replacement media segment to adjust the segment duration (e.g. inserts a corresponding number of e.g. null frames).

In a further embodiment, the media receiver provides information to the media player informing the media player about one or a plurality of non recovered media segments (out-of-band information), e.g. by sending an updated so-called manifest file.

In an embodiment, the information comprises a request to reset timestamps and/or to consider the next valid media segment as a first segment of the stream. If the receiver has already received the next media segment (e.g. a single media segment is missing), then the receiver might determine the inserted replacement media segment duration from time information of the last valid media segment before the replacement media segment and the first media segment after the replacement media segment.

In an embodiment, the media receiver and the media player are communicating by means of the HTTP protocol. In an embodiment thereto, the media player fetches a media segment by sending an HTTP request (comprising an URL address according the am manifest file received previously) to the media receiver and receiving a corresponding HTTP response comprising the corresponding media segment.

In an embodiment the (UDP) data packets received at the media receiver from the media server are associated to multicast or broadcast reception.

The present invention also concerns computer programs comprising portions of software codes in order to implement the method as described above when operated by a respective processing unit of a user device and a recipient device. The computer program can be stored on a computer readable medium. The computer-readable medium can be a permanent or rewritable memory within the user device or the recipient device or located externally. The respective computer program can be also transferred to the user device or recipient device for example via a cable or a wireless link as a sequence of signals.

In the following, detailed embodiments of the present invention shall be described in order to give the skilled person a full and complete understanding. However, these embodiments are illustrative and not intended to be limiting.

### BRIEF DESCRIPTION OF THE FIGURES

FIG. 1 shows an exemplary block diagram of a streaming system adapted for segmented streaming,

FIG. 2 illustrates a segmented media stream,

FIG. 3 shows a principle sequence of processing steps performed by a media receiver and messages exchanged between a media receiver and a media player, and

FIG. 4 shows an exemplary block diagram of an HTTP streaming system in more details.

### DETAILED DESCRIPTION

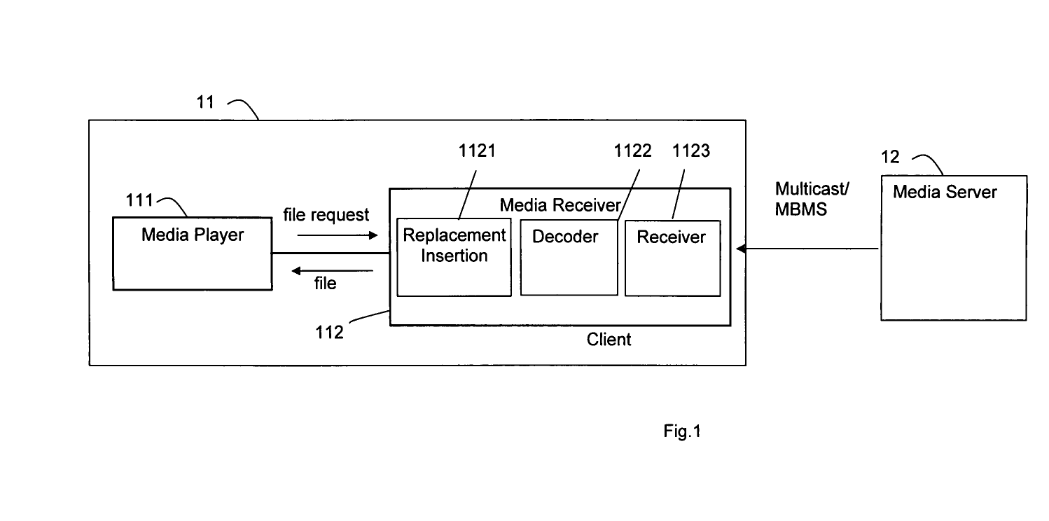

FIG. 1 shows a block diagram of an exemplary media streaming system with a media server 12 and one exemplary user device 11 (e.g. out of a plurality of user devices served by said server). The user device 11 by way of example comprises a media player 111 and a media receiver 112.

The media player 111 can be regarded a functional entity responsible for a play-out of a media stream e.g. audio media, video media or both audio and video. Thereto, the media player fetches one media file or segment after another from a media receiver as described in a manifest file previously received. The media player can be regarded as a functional entity responsible for receiving the media segments from the media server 12 and for a play-out of the corresponding media content. Thereto, from each file, the media player extracts the content or payload data to be played out and the corresponding control data (media decoding related parameters) for controlling the play-out.

The media receiver 112 decodes the media segments comprised by data packets received from a media server 12 (e.g. over a radio interface) that might multicast or broadcast such packets to a plurality of user devices, e.g. by means of the afore-mentioned MBMC. Such transmission might be performed by means of a message-based connectionless protocol, e.g. the User Datagram Protocol (UDP) as one of the members of the Internet protocol suite.

According to the example of FIG. 1, the media receiver 112 comprises a media packet receiver (e.g. a FLUTE receiver) 1123 for receiving the broadcasted or multicasted packets, a decoder 1122 for generating the media segments or files from the received packets and a replacement insertion circuit 1121 adapted for replacing non-recovered or damaged media segments by replacement segments as being discussed in more details later-on. The media segments are consecutively fetched by the media player from the media receiver by means of a file request for each file and a corresponding response carrying the requested file. Such request/response mechanism might be realized based on HTTP (e.g. HTTP request/response), or on any other suitable protocol (e.g. an internal protocol in case that the client is a single user device).

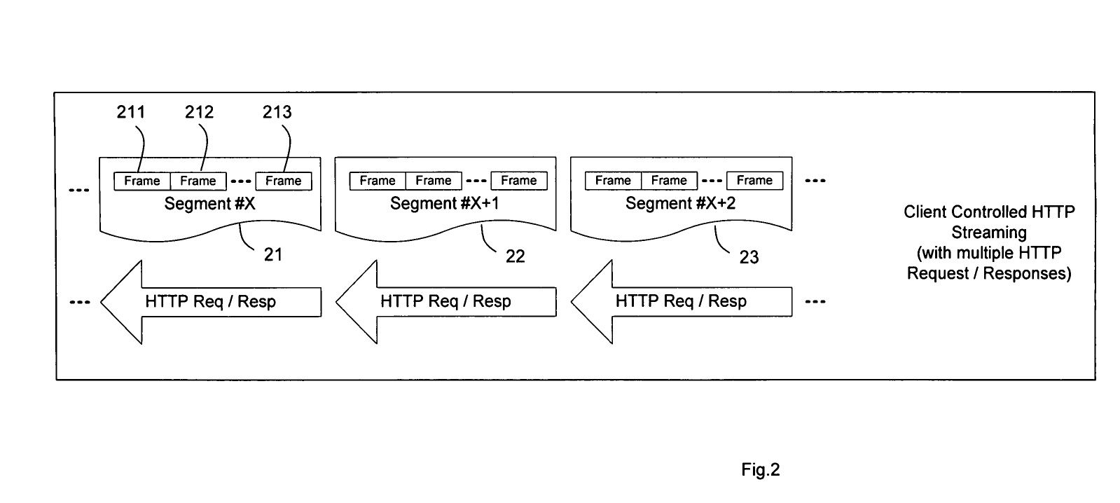

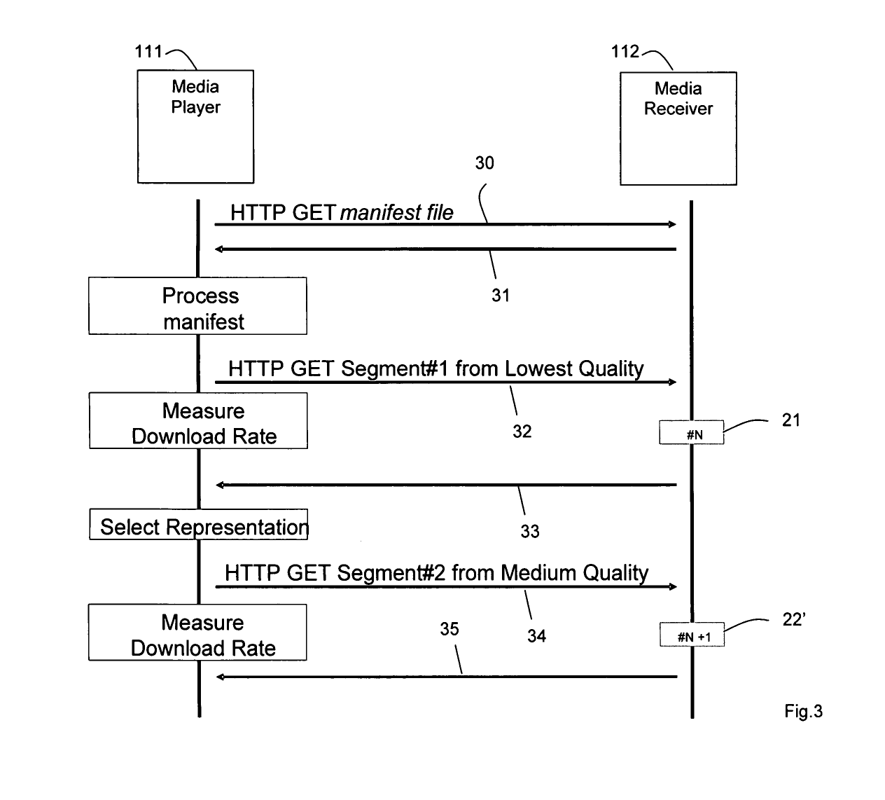

FIG. 2 illustrates a segmentation of a media stream being used in a system according to FIG. 1. On the server side, the media stream is segmented into a plurality of media segments 21, 22, 23. Each segment might comprise media data for a certain play time, e.g. 10 seconds. These segments are encoded and transmitted from the server 12 to one or a plurality of user devices 11, e.g. by means of the UDP as discussed previously. Each segment 21, 22, 23 by way of example comprises a plurality of frames 211, 212, 213, e.g. video frames or audio samples. To ensure a continuous play-out of the media content, the media player 111 takes care that it has timely available the frames for play-out. Thereto, the media player 111 fetches from the media receiver 112 one media segment after the other as independent files, e.g. by means of HTTP requests and associated HTTP responses as discussed previously and being further illustrated in the following FIG. 3. The media segments might be fragmented on average into the same number of multicast/broadcast (UDP) packets received from the media server, so that the receiver 112 can trigger an event, e.g. when a next media segment starts or when current media segment reception is finished, based on counting received multicast/broadcast packets.

FIG. 3 shows an exemplary method for fetching the media segments by the media player 111. In advance to a media play-out, the media player 11 sends a first (HTTP) request 30 to get a manifest file. The media receiver in turn transmits the requested manifest file 31. In a second request 32, a first media segment is requested (e.g. media segment 21 of FIG. 2), in turn, the media receiver transmits a response 33 comprising the first media segment. Similarly the media player sends out a request for the next segment 34 in order to receive the next response 35 comprising the next segment (e.g. segment 22).

As discussed above, during file download, the client 11 might estimate the available link bitrate (download speed). Depending on the difference between an available link bitrate and an encoded bitrate of the media, the client might select an appropriate quality representation (e.g. slightly lower than the measured link bitrate).

In case of transmission distortions (e.g. on the air interface), the receiver might not be able to recover a media segment (e.g. media segment 22), e.g. in a case that the received data is corrupted such that there is not enough information to perform a forward error correction—FEC—. The receiver then decides to discard the data of the corresponding media segment and to generate a replacement segment comprising replacement data instead of the data that should have been delivered. Thus, if e.g. segment 22 could not be properly recovered in the media receiver, the media receiver generates a replacement segment 22′ to be forwarded in the corresponding response 35.

As usually in a multicast or broadcast transmission, it is not possible for the client to request for a second transmission of lost media segment files, this method allows keeping the media player playing. Although this method might lead to (temporary) reductions in quality, it avoids a play-out stalling or a play-out abort, and thus significantly improves a quality of experience.

In an embodiment, individual media decoding related parameters are associated to each media segment. E.g. in case of MPEG-TS, exemplary parameters are: PCR (program clock reference), PTS (presentation timestamp), DTS (decoding time stamp) and other counters, which are expected to increase monotonously. In case of ISOFF based media segments, there are boxes such as a fragment sequence number in the Track Fragment header (‘mfhd’) or the media decode time (‘tfdt’). In order to properly play-out the replacement payload data, the media player needs corresponding media decoding related parameters associated to this segment. It is not sufficient for the receiver to just insert replacement data, e.g. void or null data (e.g. comprising a certain number of zero bits or bytes) to replace the content media data into a replacement file with the correct and expected URI (filename). The receiver additionally inserts appropriate decoding related parameters into the replacement file so that the media player has sufficient control information to continue with a play-out of the replacement payload data. In other words, the receiver determines expected media decoding related parameters and inserts such data together with replacement content data into a replacement segment.

For Apple HTTP live creating, the receiver may just copy the first received segment file as the dummy one, since its PCR and PTS are smaller than later received segments, it won't be played out when it is inserted.

In an embodiment, e.g. for the Apple HTTP Live Streaming solution, it is proposed to insert a dummy media segment into the m3u8 playlist (meaning modifying or newly generating the playlist file) and indicate a MPEG2-TS discontinuity using the EXT-X-DISCONTINUITY m3u8 tag. This tells the media player to reset all MPEG2-TS timestamps and consider the media segment after the discontinuity indicator as the first segment of the stream. If the receiver has already received the next media segment (a single media segment is missing), then the receiver determines the inserted dummy media segment duration from the two media segments' PCR/PTS.

In an embodiment, e.g. for an ALC/FLUTE receiver, it proposed to rewrite manifest file (m3u or m3u8 file) or generate the manifest file, since there must be at least two DISCONTINUITY tags in the manifest file: One tag before the first dummy segment and one tag before the first valid media segment. With each new media segment, any existing m3u8 manifest file is overwritten (e.g. a new m3u8 is generated for each new media segment). So the client must be aware of all m3u8 files until no dummy segment is listed anymore in the manifest file. The ALC/FLUTE receiver may need to add more than two DISCONTINUITY tags.

In an embodiment, e.g. for DASH ISO FF files it is proposed e.g. to create a new ISOFF based media segment with dummy content. The receiver determines the URI of the to-be-created media segment e.g. with HLS. If the receiver has already received the next media segment (e.g. if a single media segment is missing), then the receiver determines the actual needed media segment duration from the tfdt box of the next media segment minus the value of tfdt box from the last correctly received media segment. The receiver generates a number of null frames according to the frame rate description. The actual frames contain null data, so that the decoder skips the frame, but keeps the decoding timeline.

If multiple media segments are missing, the receiver may create new ISOFF media segments with the default media segment duration. When one media segment is correctly received, the receiver may modify the last dummy media segment to adjust the segment duration.

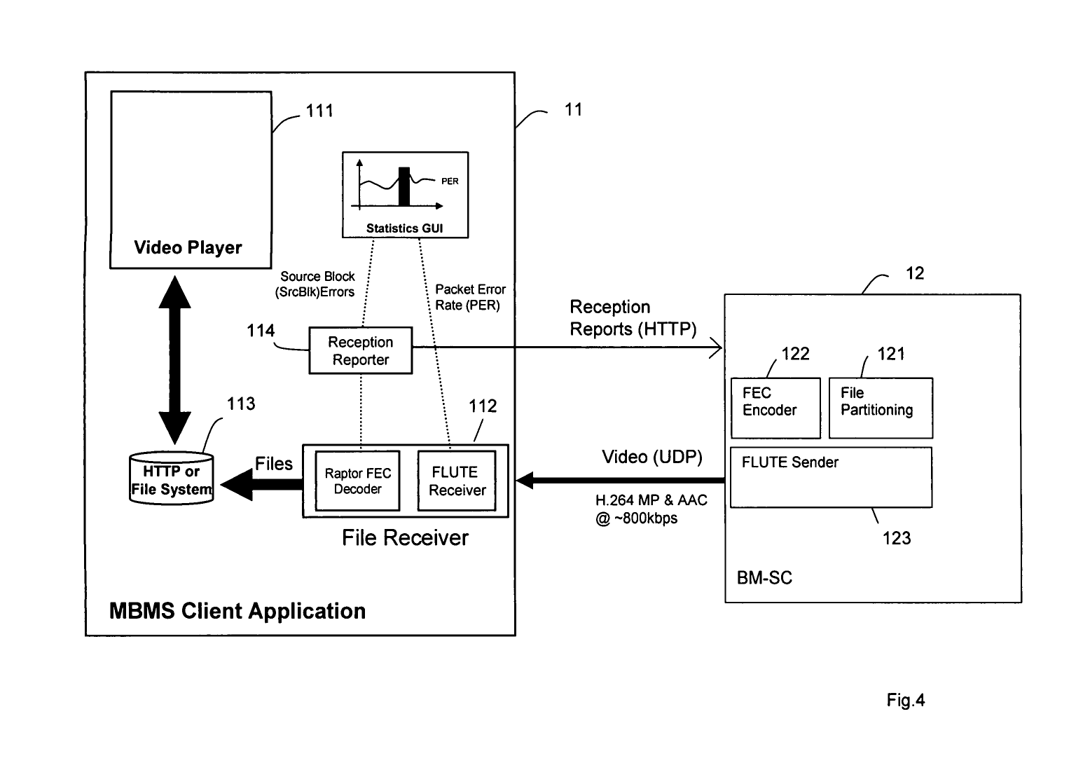

FIG. 4 shows a block diagram of an exemplary streaming system in more details. In order to provide consistency with previous figures, entities with basically similar or comparable functions have similar reference signs. The system comprises an MBMS client application comprised by the client device 11 and the media server 12 being realized as Broadcast Multicast Service Centre (BM-SC) that can be regarded as a functional entity in charge of providing the streaming service to a plurality of user applications. The client device 11 might be a mobile user device communicating over a radio interface with a gateway at the network side. The client device might comprise the file receiver 112 comprising a FLUTE receiver and a (RAPTOR) (forward error correction—FEC—) decoder. The file receiver 112 receives video data packets from the media server 12 (e.g. by means of H.248 MP & AAC, at an exemplary rate of 800 kilo bits per second) and generates media segments or files to be stored on a file system 113. The media player 111 being realized as a video player fetches from the file system one media file after the other for play-out as discussed previously. Further a reception reporting unit 114 might be provided that generates reception reports from information regarding source block errors that might be generated by a statistics GUI evaluating a packet error rate at the FLUTE receiver. Such reports might be provided in a connection oriented way (e.g. by HTTP) back to the media server. The server 12 might comprise a file partitioning circuit 121 for segmenting the media stream of received media data, a (FEC) encoder 122 for generating the media segments and a FLUT sender for sending corresponding video packets to the FLUE receiver.

1-18. (canceled)

19. A method for providing a sequence of media segments to a media player to be fetched one after another, wherein the media segments are generated from data packets received at a media receiver, the media receiver performing the following steps:
the media receiver detecting that a certain media segment cannot be recovered from the received data packets;
the media receiver obtaining content replacement data to be inserted into the replacement media segment for a play-out at the media player, wherein the replacement data is predefined and/or kept stored, e.g. a void frame, or calculated from one or a plurality of media segments previously recovered;
the media receiver determining control replacement information based one or a plurality of previously decoded media segments, the control replacement information comprising decoding and play-time related information for the play-out of the content replacement data; and
the media receiver generating a replacement media segment to be fetched by the media player instead of the certain media segment by inserting the control replacement information into the replacement media segment together with the content replacement data.

20. The method of claim 19, further comprising:
determining a time increment;
generating a new time value stamp by adding the increment to a time stamp of a recovered media segment;
and inserting the new time stamp into the replacement media segment.

21. The method of claim 19, further comprising:
incrementing one or more of: i) a counter value and ii) a sequence number of a recovered media segment; and
inserting one or more of the incremented counter value and sequence number into the replacement media segment.

22. The method of claim 19, wherein the receiver inserts a certain amount of content replacement data into the replacement media segment such that the duration of the replacement media segment corresponds to one or more of: i) a calculated duration of a non-recovered media segment to be replaced by the replacement media segment and ii) expected duration of a non-recovered media segment to be replaced by the replacement media segment.

23. The method of claim 22, wherein the media player inserts one or a plurality of frames with replacement data into the replacement media segment.

24. The method of claim 23, further comprising:
recovering a further media segment after a reception of one or plurality of non-recovered media segments; and
determining the media segment duration from timing information of both the media segment preceding the non-recovered media segment and the further media segment, e.g. calculating a time difference between a time value indicated in the further media segment minus a time value of the media segment preceding the non-recovered media segment.

25. The method of claim 19, wherein in a case that multiple consecutive media segments have not been recovered or are missing, the media receiver performs:
creating a plurality of corresponding replacement media segments with a default media segment duration; and
at a first correct reception after multiple media segments, modifying a further replacement media segment to follow the plurality of consecutive replacement segments to adjust the segment duration such that the duration of the replacement media segments are adapted to the non-recovered or missing media segments, e.g. by inserting a corresponding number of void frames.

26. The method of claim 19, wherein the media receiver provides information to the media player for informing the media player about one or a plurality of non recovered media segments.

27. The method of claim 26, wherein the information comprises a request to reset timestamps and/or to consider a next valid media segment as a first segment of the stream.

28. The method of claim 19, wherein the media receiver and the media player communicate by means of the HTTP protocol.

29. The method of claim 28, wherein the media player fetches a media segment by sending an HTTP request to the media receiver, the HTTP request comprising an URL address according the a manifest file previously received, to receive a corresponding HTTP response comprising the media segment.

30. The method of claim 29, wherein the media receiver receives media data packets broadcasted or unicasted by a media server and generates the media segments based on the received data packets.

31. A computer program loadable into a processing unit associated to a receiver device, the computer program comprising code adapted to execute the method of claim 19.

32. A receiver device adapted for providing a sequence of media segments to a media player for a play-out of a media stream, comprising
a receiver adapted for receiving data packets associated to the media stream; and
a generator adapted for:
generating a plurality of media segments to be fetched by the media player one after another, wherein the generator is further adapted to detect that a certain media segment cannot be recovered from the received data packets, and generate a replacement media segment to be fetched by the media player instead of the certain media segment,
generating content replacement data for a play-out by the media player and control replacement data comprising decoding and play-time related information for the play-out of the content replacement data,
determining the control replacement data from one or a plurality of previously decoded media segments, and
inserting the control replacement data into the replacement media segment together with the content replacement data.
